(19) United States
(12) Patent Application Publication
(10) Pub. No.: US 2026/0307097 A1
(43) Pub. Date: Oct. 8, 2026

(54) EXTRUSION PUMP FOR EXTRUDING HIGHLY VISCOUS MATERIAL

(71) Applicant: Precision Valve & Automation, Inc., Halfmoon, NY (US)

(72) Inventors: Jonathan Neal Urquhart, Saratoga Springs, NY (US); Jason Schoen, Clifton Park, NY (US)

(21) Appl. No.: 19/636,536

(22) Filed: Apr. 1, 2026

Related U.S. Application Data
(60) Provisional application No. 63/782,226, filed on Apr. 2, 2025.

(51) Int. Cl. B05C 5/02

(52) U.S. Cl. CPC B05C 5/02

(57) ABSTRACT

An extrusion pump having a container retaining mechanism configured to secure a container pre-filled with a highly viscous material, the container having an open top end and an open bottom end, and a driving mechanism configured to drive a ram through the container retained by the container retaining mechanism to extrude the highly viscous material from the container through the open bottom end of the container to supply a dispensing machine with the highly viscous material. A method and system are also provided.

### CROSS-REFERENCE TO RELATED APPLICATIONS

This application claims the benefit of and priority to U.S. Provisional Application No. 63/782,226, filed Apr. 2, 2025, and entitled “Extrusion Pump for Extruding Highly Viscous Material.” The entire contents are hereby incorporated by reference.

### BACKGROUND

The following relates to extruding highly viscous material, and more specifically to an extrusion pump for extruding highly viscous material from a pre-filled container to supply a dispensing valve.

### SUMMARY

An aspect relates to an extrusion pump comprising: a container retaining mechanism configured to secure a container pre-filled with a highly viscous material, the container having an open top end and an open bottom end, and a driving mechanism configured to drive a ram through the container retained by the container retaining mechanism to extrude the highly viscous material from the container through the open bottom end of the container to supply a dispensing machine with the highly viscous material.

Another aspect relates to a method of extruding a highly viscous material from a pre-filled container, the method comprising: inserting the pre-filled container containing the highly viscous material into a container retaining mechanism of an extrusion pump, retaining the pre-filled container within the container retaining mechanism, and driving a ram through the pre-filled container to extrude the highly viscous material from the pre-filled container through an open bottom end of the pre-filled container such that the highly viscous material is extruded in a same direction as the ram moves to extrude the highly viscous material.

Another aspect relates to a system comprising: an extrusion pump having a container retaining mechanism configured to secure a container pre-filled with a highly viscous material, the container having an open top end and an open bottom end, a driving mechanism configured to drive a ram through the container retained by the container retaining mechanism to extrude the highly viscous material from the container through the open bottom end of the container in a same direction as the ram moves, and a dispensing machine fluidically coupled to receive the highly viscous material extruded from the container.

The foregoing and other features of construction and operation will be more readily understood and fully appreciated from the following detailed disclosure, taken in conjunction with accompanying drawings.

### BRIEF DESCRIPTION OF THE DRAWINGS

Some of the embodiments will be described in detail, with reference to the following figures, wherein like designations denote like members, wherein:

FIG. 1A depicts a known extrusion pump for extruding thermal interface material from a container to supply a dispensing machine;

FIG. 1B depicts a known extrusion pump for extruding thermal interface material from a container to supply a dispensing machine;

FIG. 2A depicts an extrusion process of the known extrusion pump;

FIG. 2B depicts the extrusion process of the known extrusion pump;

FIG. 3A depicts a first position of the ram, prior to extruding material from a pre-filled container, in accordance with embodiments of the present invention.

FIG. 3B depicts a second position of the ram, during an extrusion process, in accordance with embodiments of the present invention;

FIG. 3C depicts a third position of the ram, during an extrusion process, in accordance with embodiments of the present invention;

FIG. 3D depicts a fourth position of the ram, which has been driven through the pre-filled container, in accordance with embodiments of the present invention;

FIG. 3E depicts a fifth position of the ram, which has been retracted, in accordance with embodiments of the present invention;

FIG. 4 depicts a coupling of the extrusion pump and a dispensing machine, in accordance with embodiments of the present invention;

FIG. 5 depicts a pump in between the extrusion pump and the dispensing machine, in accordance with embodiments of the present invention;

FIG. 6A depicts an embodiment of a pre-filled container, in accordance with embodiments of the present invention;

FIG. 6B depicts a cross-sectional view of the container without material contained inside, in accordance with embodiments of the present invention; and

FIG. 7 depicts a flow chart of a method for extruding a highly viscous material from a pre-filled container, in accordance with embodiments of the present invention.

### DETAILED DESCRIPTION

A detailed description of the hereinafter described embodiments of the disclosed apparatus and method are presented herein by way of exemplification and not limitation with reference to the Figures. Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure.

As a preface to the detailed description, it should be noted that, as used in this specification and the appended claims, the singular forms “a”, “an” and “the” include plural referents, unless the context clearly dictates otherwise.

In brief overview, thermal interface materials are materials used to improve distribution of heat between integrated components and heat dissipating devices. Thermal interface material is abrasive and comprises highly viscous pastes or compounds often shipped in steel containers of various sizes (e.g. one gallon or five gallon containers). Generally, the thermal interface material is placed between a heat-generating chip and/or component and a substrate or heat dissipating device. For placing the thermal interface material, one or more dispensing valves of a dispensing machine dispense the thermal interface material at precise locations on a target surface/substrate. An example of a dispensing machine is a DELTA 8 Coating/Dispensing machine sold by Precision Valve and Automation, Inc. of Halfmoon, NY. Examples of dispensing valve for dispensing thermal interface material are SD100, SB300 SERIES, and BP50 sold by Precision Valve and Automation, Inc. of Halfmoon, NY. Extrusion pumps are used to supply the dispensing valves with the thermal interface material.

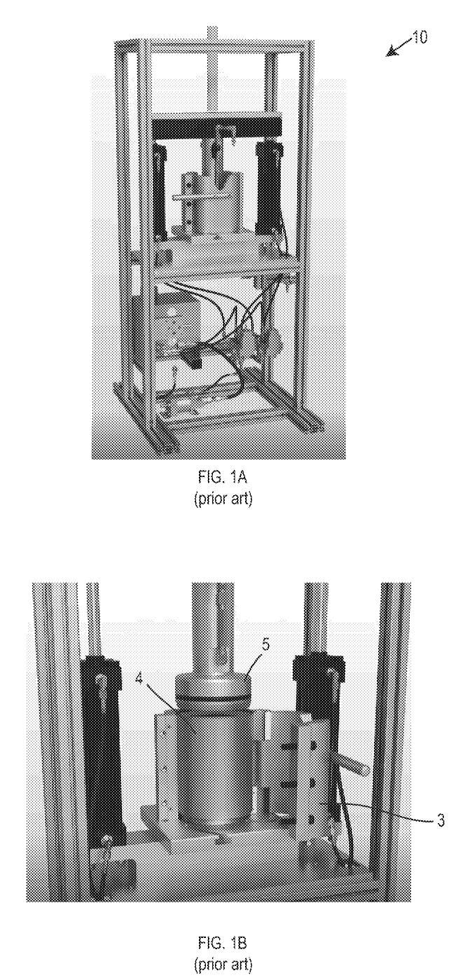

FIGS. 1A and 1B depicts a known extrusion pump 10 for extruding thermal interface material from a pre-packaged container 4 to supply a dispensing machine. As shown in FIG. 1A, the extrusion pump 10 is a hydraulic metering pump for dispensing highly abrasive, highly viscous pastes and compounds (e.g. thermal interface materials) packaged in metal pre-packaged containers 4 of various volume (e.g. one gallon, five gallon, etc.). The extrusion pump 10 extrudes thermal interface material from the pre-packaged container 4 provided by a supplier of thermal interface material. The extrusion process minimizes shear and maintains material integrity. The pre-packaged container 4 is secured within the extrusion pump 10 by a clamshell-type securing means 3 during the extrusion process. The extrusion pump 10 operates as a hydraulic press, and material is extruded from the pre-packaged container 4 as a hydraulic intensifier pump forces a ram 5 into the pre-packaged container 4. An exit path in a center of the ram 5 allows material to flow out of the extrusion pump 10 in an upwards direction away.

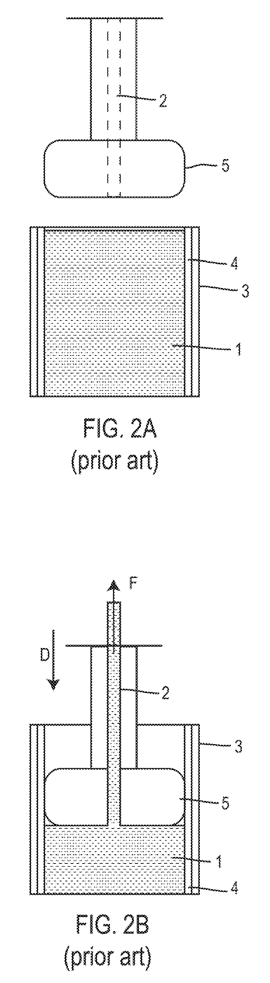

FIGS. 2A and 2B depict the extrusion process of the known extrusion pump 10. As shown in FIG. 2A, the pre-packaged container 4 filled with thermal interface material 1 is secured in place by the securing means 3. The ram 5 is located above the pre-packaged container 4 and has not made contact with the thermal interface material 1. To perform the extrusion process, the ram 5 is moved in a driving direction D towards the pre-packaged container 5 to extrude the material 1 from the pre-packaged container 4. As shown in FIG. 2B, as the ram 5 is driven in the driving direction D, the material 1 is forced up through exit path 2 (e.g. channel or bore) in the ram 5 in a flow direction F. The flow direction F is opposite to the driving direction D. The material 1 is forced up through exit path 2 and conveyed to a dispensing machine via a fluid hose. With the design and extrusion process illustrated in FIGS. 1A-2B, thermal interface material residue remains in the pre-packaged container 4 between the bottom of the ram 5 and the inner bottom surface of the pre-packaged container 4 after the extrusion process is complete. The residual thermal interface material 1 is considered waste because the pre-packaged container is not reusable. The pre-packaged container 4 with residual thermal interface material 1 must be removed from the securing means 3 after the extrusion process, and a new pre-packaged container 4 must be inserted into the securing means 3 before starting a new extrusion process.

Embodiments of the present invention reduce or eliminate residual thermal interface material by reversing the flow direction F of the extruded material such that the flow direction F is the same as the driving direction D of the ram, extruding the material 1 from an open bottom end of a pre-filled container. An exit path for the extruded material is located below the pre-filled container and conveyed to a dispensing machine. An extrusion pump according to exemplary embodiments of the invention include a container retaining mechanism 30 configured to secure a container 20 pre-filled with a highly viscous material, and a driving mechanism configured to drive a ram 50 through the container 20 secured by the container retaining mechanism 30 to extrude highly viscous material from the container 20 through an open bottom end of the container 20 to supply a dispensing valve with the highly viscous material. The driving mechanism includes the ram 50 connected to a press beam or press plate. The driving mechanism can be operated with a servo motor, a pneumatic drive, or hydraulically.

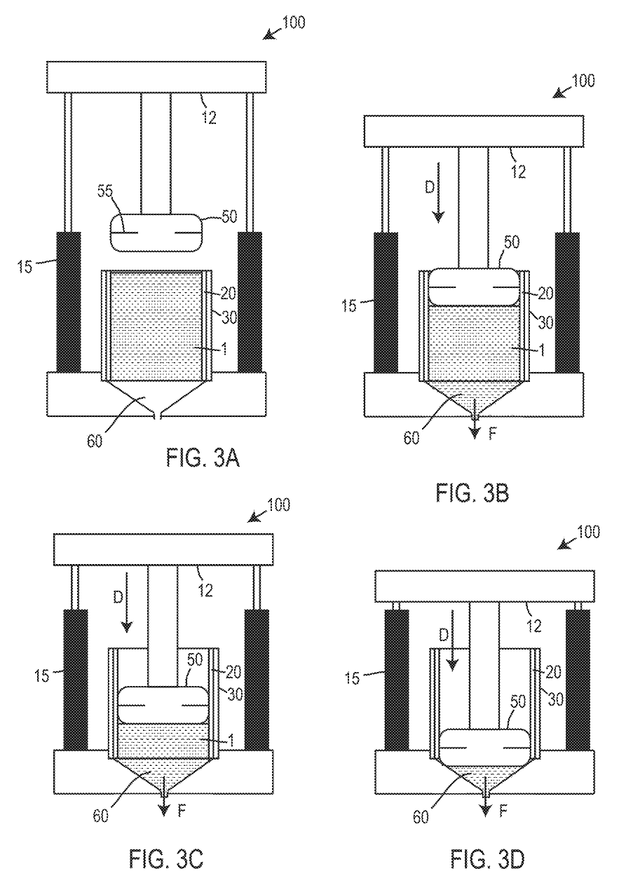

FIGS. 3A-3E depict an extrusion sequence of an extrusion pump, in accordance with embodiments of the present invention. The extrusion pump 100 includes a hydraulic press having at least two hydraulic cylinders 15 connected at ends of a press beam 12 for effectuating the movement of the ram 50 through the container 20. For instance, the ram 50 is mechanically connected to the press beam 12, and, in response to actuation of the hydraulic cylinders 15, the press beam 12 moves thereby driving the ram 50 in a driving direction D to extrude material from the container 20. After the material has been extruded from the container 20, the hydraulic cylinders 15 are actuated to move the press beam 12 in a reverse direction thereby lifting the ram 50 out of the container 20. The ram 50 of the extrusion pump 100 includes an external seal 55 extending around a circumference of the ram 50. The external seal 55 is configured to remain in sealing contact with an inner surface of the container 20 as the ram 50 is driven through the container 20 so that material 1 does not escape upwards in between the ram 50 and the inner surface of the container 20. The seal 55 can comprise one seal fully or partially extending circumferentially around the ram 50, or can comprise one or more seals that fully or partially extend around the outer circumference of the ram 50. Further, the extrusion pump 100 also includes the container retaining mechanism 30. The container retaining mechanism 30 is configured to retain or otherwise hold the pre-filled container 20 in position during the extrusion process. In one embodiment, the container retaining mechanism 30 is a clamshell design that has a first half that is stationary and a second half that swings away from the first half about a fixed connection to allow insertion of the container 20. The second half is then pushed back against the first half to secure the container 20; removable fasteners may be used to secure the first half and the second half of the clamshell securing mechanism. In another embodiment, the container securing mechanism 30 is a recess in block 17 in which the container 20 sits, being retained by the side walls of the block 17 along the recess in the block 17. Block 17 is a machined block either formed from two or more sections or a structurally integral block that is machined to form a fluid exit path 60, within the block 17, for the fluid to leave the extrusion pump 100.

The extrusion pump shown in FIGS. 3A-3E includes a container 20 pre-filled with material 1 (e.g. thermal interface material), a container retaining mechanism 30 securing the container 20, and a driving mechanism configured to drive a ram 50 through the container 20 to extrude the highly viscous material 1 from the container 20. FIG. 3A depicts a first position of the ram 50, prior to extruding the material 1 from the container 20, in accordance with embodiments of the present invention. The ram 50 is located above the pre-filled container 20 and has not made contact with the material 1. The container retaining mechanism 30 secures the pre-filled container 20 in place. To perform the extrusion process, the ram 50 is moved in a driving direction D towards the pre-filled container 20 to extrude the material 1 from the pre-filled container 20. FIG. 3B depicts a second position of the ram 50, during an extrusion process, in accordance with embodiments of the present invention. As shown in FIG. 3B, as the ram 50 is driven in the driving direction D, the material 1 is forced through an open bottom end of the container 20 and container retaining mechanism 30 in a flow direction F. In contrast with the known extrusion pump 10 depicted in FIGS. 1A-2B, the flow direction F is the same as the driving direction D of the ram 50 and does not flow through an exit path within a ram or follower plate. The material 1 is forced downward and out of the container 20 through an exit path 60 located below the container 20 and container retaining mechanism 30 and conveyed to a dispensing machine, for example, via a fluid hose. FIG. 3C depicts a third position of the ram 50, during an extrusion process, in accordance with embodiments of the present invention. As shown in FIG. 3C, the ram 50 is further driven in the driving direction D to force more material 1 through an open bottom end of the container 20 and container retaining mechanism 30 in a flow direction F. FIG. 3D depicts a fourth position of the ram 50, which has been driven through the container 20, in accordance with embodiments of the present invention. The ram 50 has been further driven in driving direction D from the position shown in FIG. 3C to extrude all of the material 1 from the container 20 and into exit path 60 in flow direction F. The bottom end of the ram 50 is shown to extend below a bottom end of the container 20 but could also be driven to be flush with the bottom end of the container 20 to remove all of the material 1 from the container 20. FIG. 3E depicts a fifth and final position of the ram 50, during an extrusion process, in accordance with embodiments of the present invention. Here, the ram 50 has been retracted in a reverse direction to completely exit the now empty container 20. The container 20 is then removed from the container retaining mechanism 30 and reused or discarded.

With the inventive design and extrusion process illustrated in FIGS. 3A-3D, the ram 50 can force all of the material 1 out of the container 20 without leaving residue within the container 20 after the extrusion process is complete. And, as will be described below, if some residue does remain in the container 20, the container 20 is reusable and therefore any potential residue left from a previous extrusion process can be extruded from the container 20 in a subsequent extrusion process.

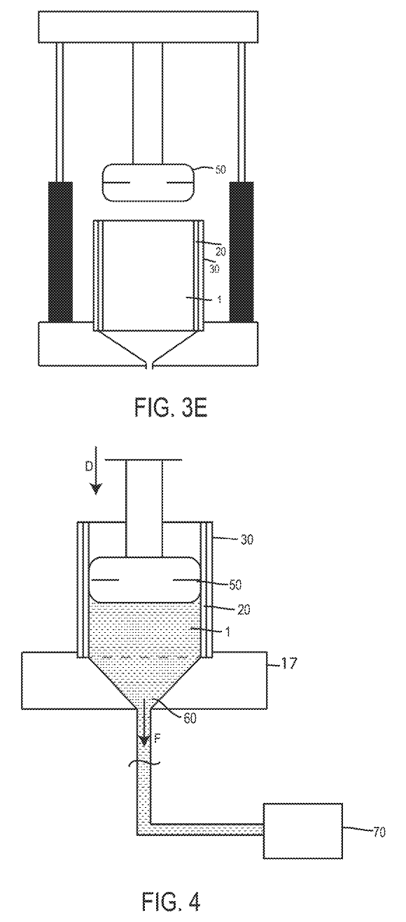

The material 1 is extruded from the pre-filled container 20 and forced through exit path 60 and conveyed to a dispensing machine 70 fluidically coupled to the exit path 60 of the extrusion pump. FIG. 4 depicts the coupling of the extrusion pump 100 and a dispensing machine 70, in accordance with embodiments of the present invention. The exit path 60 may include a fluid hose having an inlet section proximate the bottom end of the block 17 to receive the extruded material 1. The fluid hose fluidically connects the extrusion pump 100 to the dispensing machine 70. The length of the fluid hose varies and is thus shown with a break to indicate variable hose length. The dispensing machine 70 is shown schematically but a distal end of the fluid hose can be fluidically connected directly to a dispensing valve or to a fluid supply of the dispensing valve of the dispensing machine 70, or to another connection of the dispensing machine 70.

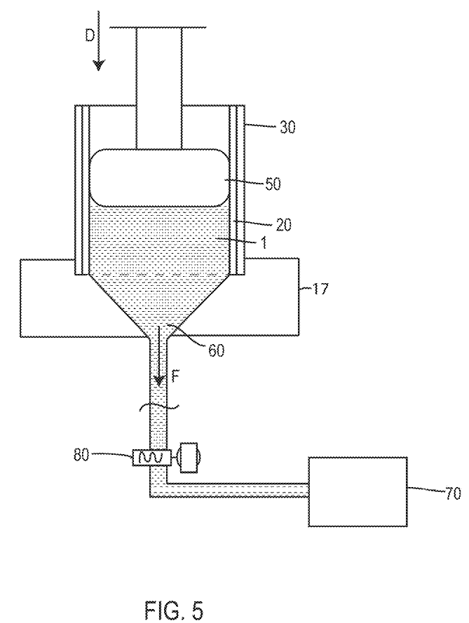

Optionally, a pump 80 can be located downstream of the open bottom end of the block 17. FIG. 5 depicts the pump 80 in between the extrusion pump and the dispensing machine 70, in accordance with embodiments of the present invention. The pump 80 is configured to create a pressure within the exit path 60 to help convey the material 1 through a fluid hose and/or to build a pressure within the fluid hose prior to reaching the dispensing machine 70.

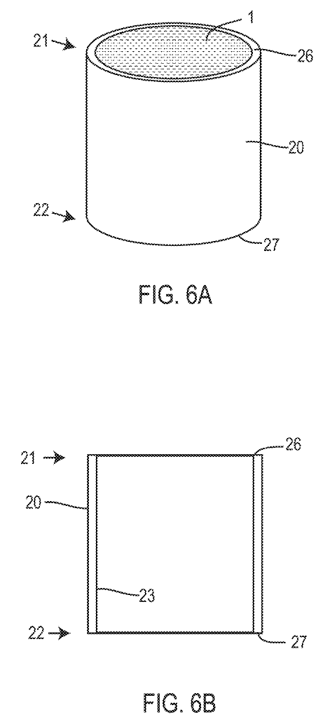

Referring still to the drawings, FIG. 6A depicts an embodiment of a pre-filled container 20, in accordance with embodiments of the present invention. The pre-filled container 20 illustrated in FIG. 6A includes material 1 and is ready for insertion into the container retaining mechanism 30 for extrusion of the material 1. The pre-filled container 20 is a cylinder having an axial opening therethrough, with a first open end 21 and a second open end 22. A top edge 26 defines the perimeter of the first open end 21 and a bottom edge 27 defines the perimeter of the second open end 22. Alternatively, the container 20 may not be a cylinder and have a different cross-section, such as square, rectangular, elliptical, hexagonal, and the like. Pre-filled container 20 is comprised of metal, such as steel or other alloys. Alternatively, the pre-filled container 20 can be made of paper or plastic, and with or without a foil liner. An inner diameter of the container 20 corresponds to an outer diameter of the ram 50. After the material 1 is extruded, the container 20 can be reused. FIG. 6B depicts a cross-sectional view of a container 20 without material 1, in accordance with embodiments of the present invention. A cylindrical inner wall surface 23 extends from the first open end 21 to the second open end 22. The empty container 20 shown in FIG. 6B may be filled with material 1. In an exemplary embodiment, the empty container 20 is filled with material by transferring material from a pre-packaged container (e.g. packaged and shipped by a manufacturer/supplier of thermal interface material).

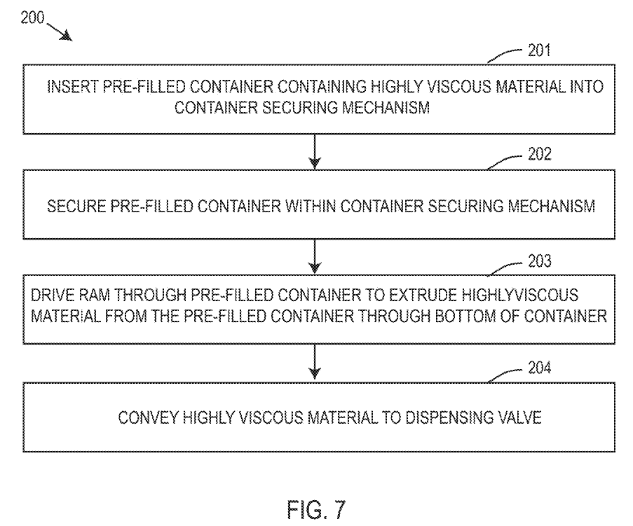

FIG. 7 depicts a flow chart of a method 200 for extruding a highly viscous material from a pre-filled container, in accordance with embodiments of the present invention. In step 201, the pre-filled container 20 containing the highly viscous material is inserted into a container retaining mechanism 30 of an extrusion pump. In step 202, the pre-filled container is secured within the container retaining mechanism 30. In step 203, a ram 50 is driven through the pre-filled container 20 to extrude the highly viscous material from the pre-filled container 20 through an open bottom end 22 of the pre-filled container 20 such that the highly viscous material is extruded in a same direction (F) as the ram 50 moves (D) to extrude the highly viscous material. In step 204, the extruded material is conveyed to a dispensing machine and/or dispensing valve.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. An extrusion pump comprising:
a container retaining mechanism configured to secure a container pre-filled with a highly viscous material, the container having an open top end and an open bottom end; and
a driving mechanism configured to drive a ram through the container retained by the container retaining mechanism to extrude the highly viscous material from the container through the open bottom end of the container to supply a dispensing machine with the highly viscous material.

2. The extrusion pump of claim 1, wherein the highly viscous material is extruded from the container in a same direction as a driving direction of the ram.

3. The extrusion pump of claim 1, wherein the ram comprises an external seal extending around a circumference of the ram, the external seal configured to effectuate a seal against an inner surface of the container as the ram is driven through the container.

4. The extrusion pump of claim 1, wherein the highly viscous material extruded from the container does not flow through the ram or in a direction opposite of a driving direction of the ram.

5. The extrusion pump of claim 1, wherein the driving mechanism is a hydraulic press including at least one hydraulic cylinder.

6. The extrusion pump of claim 1, wherein the driving mechanism is a servo driving mechanism.

7. The extrusion pump of claim 1, further comprising a pump located downstream of the open bottom end of the container, configured to create a pressure for conveying the highly viscous material to the dispensing machine.

8. The extrusion pump of claim 1, wherein a distal end of a fluid hose attached to the extrusion pump is fluidically connected to the dispensing machine or a fluid supply of the dispensing machine.

9. The extrusion pump of claim 1, wherein the container retaining mechanism further includes a machined block having a recess defining sidewalls that retain the container in position.

10. A method of extruding a highly viscous material from a pre-filled container, the method comprising:
inserting the pre-filled container containing the highly viscous material into a container retaining mechanism of an extrusion pump;
retaining the pre-filled container within the container retaining mechanism; and
driving a ram through the pre-filled container to extrude the highly viscous material from the pre-filled container through an open bottom end of the pre-filled container such that the highly viscous material is extruded in a same direction as the ram moves to extrude the highly viscous material.

11. The method of claim 10, further comprising conveying the extruded highly viscous material from the open bottom end to a dispensing valve via at least one fluid hose.

12. The method of claim 11, further comprising operating a pump along the at least one fluid hose to create a high-pressure feed to the dispensing machine.

13. A system comprising:
an extrusion pump having a container retaining mechanism configured to secure a container pre-filled with a highly viscous material, the container having an open top end and an open bottom end;
a driving mechanism configured to drive a ram through the container retained by the container retaining mechanism to extrude the highly viscous material from the container through the open bottom end of the container in a same direction as the ram moves; and
a dispensing machine fluidically coupled to receive the highly viscous material extruded from the container.

14. The system of claim 13, wherein the ram comprises an external seal extending around a circumference of the ram, the external seal configured to seal against an inner surface of the container as the ram is driven through the container.

15. The system of claim 13, further comprising a pump located downstream of the open bottom end of the container, the pump configured to create a pressure for conveying the highly viscous material to the dispensing machine.

16. The system of claim 13, further comprising a fluid hose fluidically connecting the extrusion pump to the dispensing machine.

17. The system of claim 13, wherein the container is a cylinder having an axial opening therethrough, the axial opening defined by the open top end and the open bottom end.

18. The system of claim 17, wherein the container is reusable after extrusion of the highly viscous material from the container.

19. The system of claim 13, wherein the container retaining mechanism includes a machined block having a recess defining sidewalls that retain the container in position.

20. The system of claim 13, wherein the driving mechanism is a hydraulic press including at least two hydraulic cylinders connected to a press beam.
